(19) United States
(12) Patent Application Publication
(10) Pub. No.: US 2015/0000092 A1
(43) Pub. Date: Jan. 1, 2015

(54) DISMANTLING DEVICE

(71) Applicant: Jun-Fan CHEN, Taichung City (TW)

(72) Inventor: Jun-Fan CHEN, Taichung City (TW)

(21) Appl. No.: 13/931,937

(22) Filed: Jun. 30, 2013

(51) Int. Cl. B25B 27/00

(52) U.S. Cl. CPC B25B 27/00
USPC 29/282

(57) ABSTRACT

A dismantling device including a main body, a driving member and an insert is provided. The main body includes a through hole. The driving member is rotatably assembled to the main body. The insert is rotatably disposed in the assembling hole of the first portion. Whereby, an object to be dismantled can be placed in the hole to abut against the insert. A tool is used to drive the driving member to rotate. A protrusion of the driving member is inserted into the through hole for holding the object so that the object can be rotated to be dismantled. As a result, the object can be hold stably by the insert so that the dismantling device can be used for dismantling objects in different sizes.

### BACKGROUND OF THE INVENTION

1. Field of the Invention

The present invention relates to a dismantling device, more particularly, to a dismantling device for a tubular member or a rod member.

2. Description of the Prior Art

A loading and unloading device suitable for various pipes is disclosed in TW M343750. The device includes arcuate connection portion and a sleeve portion. A hollow portion is located between two ends of the connection portion. The hollow portion is pivoted with a driving member. One end of the sleeve portion is pivoted with one end of the connection portion, and the other end of the sleeve portion is connected with the other end of the connection portion via a fixation member to form a sleeve hole. The driving member includes a driving portion located at the peripheral edge of the connection portion. A pressing portion is disposed in the sleeve hole. Through the aforementioned structure, the loading and unloading device can be used for various pipes whose diameters are different.

However, the structure disclosed in TW M343750 is suitable for pipes with diameters within a limited range due to the limitation of the connection portion and the sleeve portion. Once an object to be dismantled is, for the device, too big, too small or has an irregular shape, the driving member cannot effectively clamp the object, thus affecting the loading or unloading of the object. As a result, the device like that disclosed in TW M343750 can be applied only to few specific pipes, and thus it is not utility.

The present invention is, therefore, arisen to obviate or at least mitigate the above mentioned disadvantages.

### SUMMARY OF THE INVENTION

An object of the present invention is to provide a dismantling device which is suitable for various objects whose sizes and shapes are different.

To achieve the above and other objects, a dismantling device includes a main body, a driving member and an insert. The main body includes a first portion and a second portion, wherein the first portion includes an assembling hole, and the second portion includes a through hole. The driving member is rotatably disposed in the assembling hole of the first portion. The driving member includes a first end and a second end, wherein the first end includes a driving portion, and the second end includes an abutting portion. The abutting portion being able to goes into the through hole via the rotation of the driving member. The insert is detachably assembled with the second portion and in the through hole.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a partial breakdown drawing according to a preferred embodiment of the present invention;

FIG. 2 is a perspective drawing according to a preferred embodiment of the present invention;

FIG. 3 is a top view according to a preferred embodiment of the present invention; and

FIGS. 4 and 5 are drawings illustrating a dismantling device in use according to a preferred embodiment of the present invention.

### DETAILED DESCRIPTION OF THE PREFERRED EMBODIMENTS

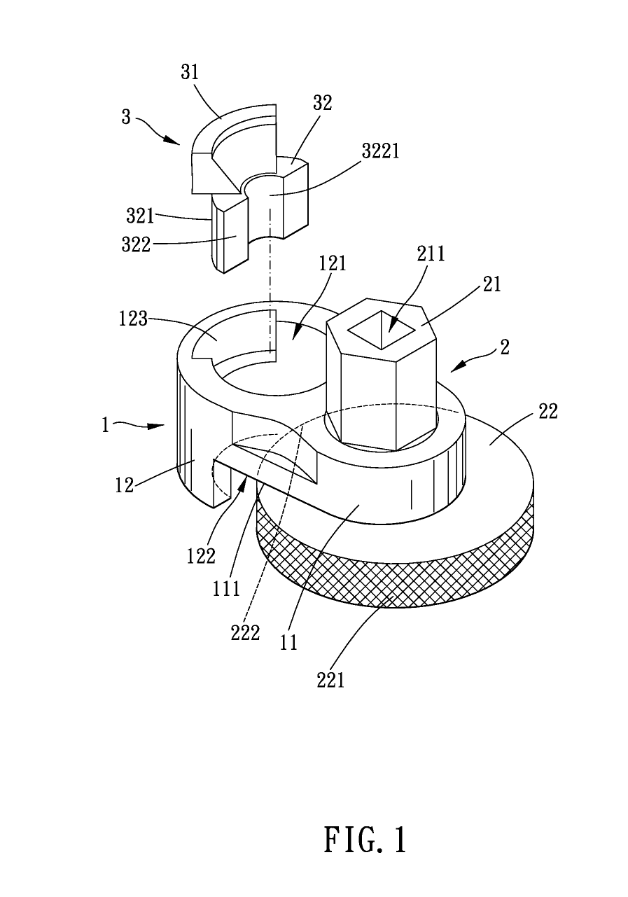

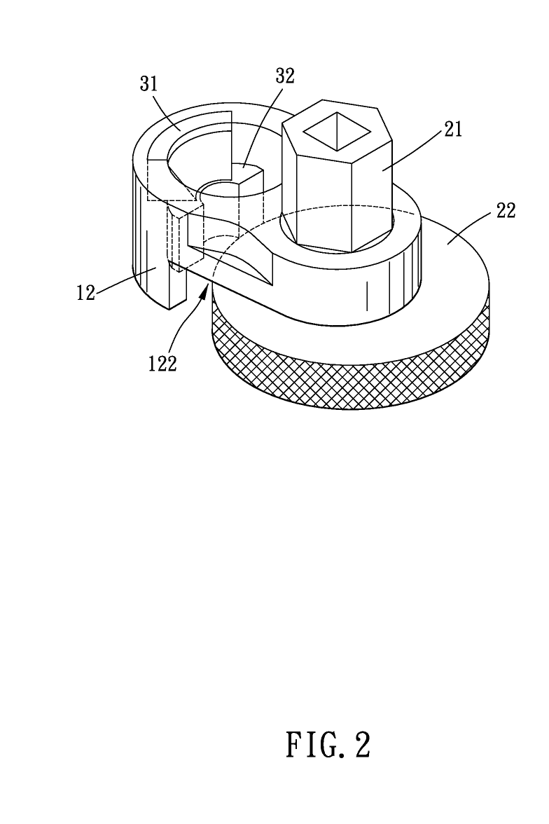

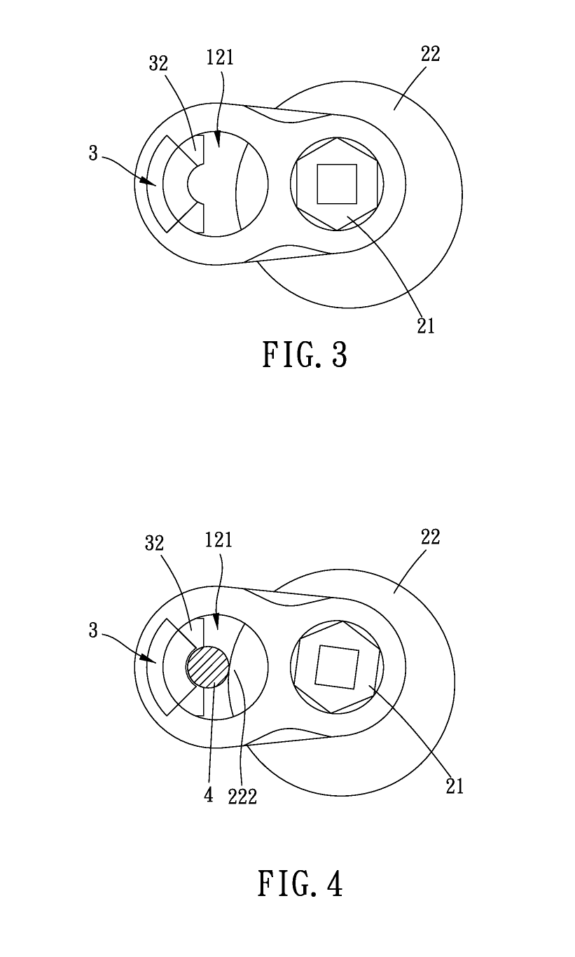

FIGS. 1 to 3 show a dismantling device according to a preferred embodiment of the present invention. The dismantling device includes a main body 1, a driving member 2 and an insert 3.

The main body 1 includes a first portion 11 and a second portion 12. The first portion 11 is thinner than the second portion 12 and formed with a stepped surface 111 on one side thereof, and the first portion 11 includes an assembling hole. The second portion 12 includes a through hole 121 and a lateral opening 122 extending radially along the through hole. The through hole 121 is circular (however, may be non-circular in other embodiments), and the lateral opening 122 faces the stepped surface 111 of the first portion 11. The second portion 12 is formed with an assembling portion 123 on an inner surface corresponding to the through hole 121, and the assembling portion 123 is a generally arcuate recess.

The driving member 2 is rotatably disposed through the assembling hole of the first portion. The driving member 2 includes a first end and a second end, wherein the first end has a driving portion 21, and the second end is near the lateral opening 122 and has an abutting portion 22. The driving portion 21 is formed as a polygonal post and includes a square hole 211 for connection of a tool such as wrench. In other embodiments, the driving portion 21 is provided with a structure having a shape corresponding to that of a tool. The abutting portion 22 is disposed eccentrically on the driving member 2 and located on one side surface of the first portion 11 near the lateral opening 122. The abutting portion 22 is formed as a circular plate and a circumferential surface thereof is formed with a frictional structure 221 (may be a convex-concave structure). One end of the abutting portion 22 is formed with a protrusion 222 extending into the lateral opening 122. The abutting portion 22 can be rotated relative the main body 1 through driving the driving member so that the abutting portion 22 goes through the lateral opening 122 and into the through hole 121.

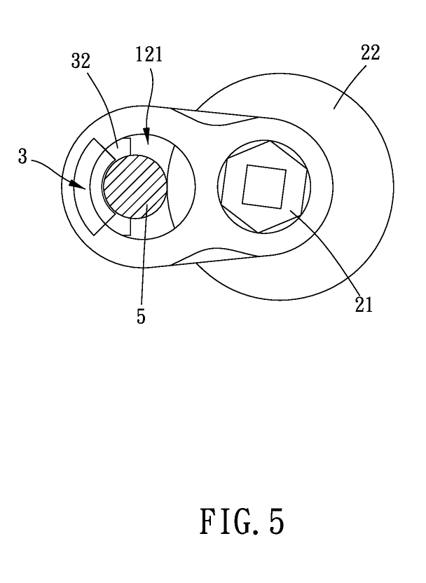

The insert 3 is detachably assembled with the second portion 12 and in the through hole 121. The insert 3 is disposed on one side of the second portion 12 remote from the first portion 11. In this embodiment, the insert 3 includes a connection portion 31 and a head portion 32, wherein the connection portion 31 is detachably assembled with the assembling portion 123, and the connection portion 31 and the assembling portion 123 have corresponding shapes so that the insert 3 and the assembling portion 123 can be detachably assembled and positionally engaged with each other. The head portion 32 is formed as a generally arcuate block and extends into the through hole 121. The head portion 32 includes corresponding first surface 321 and second surface 322. The first surface 321 is engaged with an inner surface in the through hole 121 of the second portion 12 (the shape of the first surface 321 may be designed to mate with that of the second portion 12, such as that in this embodiment the first surface 321 is formed as an arcute surface which can be perfectly engaged with the inner surface in the through hole 121). The second surface 322 faces the first portion 11 and is formed with a concave surface 3221.

Whereby, for dismantling an object 4, the object 4 (such as tubular member) is inserted in the through hole 121 of the second portion 12 so that the object 4 is abutted against the head portion 32 of the insert 3; a tool (such as wrench) is coupled with the driving portion 21 and is used to drive the driving member 2 rotating relative to the main body 1, through which the protrusion 222 of the abutting portion 22 can move into the through hole 121 so as to abut against the object 4 (as shown in FIG. 4). As a result, the head portion 32 of the insert 3 and the protrusion 222 of the abutting portion 22 can fixedly clamp the object 4, and therefore, the tool, the dismantling device and the object 4 can be rotated simultaneously and the object 4 can be dismantled.

In the present invention, the insert is designed to be cooperated with an object to be dismantled. For example, for a large-sized object, the insert can be dismantled from the dismantling device to provide a large space, or another thin insert can be used to dismantle the large-sized object 5 (as shown in FIG. 5). In addition, an insert can be chosen according to the shape of an object to be dismantled (for example, the insert may be flat or arcuate), whereby increasing abutting area of the dismantling device and the object to facilitate the dismantling. Compared to the conventional structure, the dismantling device of the present invention is suitable for various objects whose sizes and shapes are different, and is conveniently to use and utility.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A dismantling device, including:
a main body, including a first portion and a second portion, the first portion including an assembling hole, the second portion including a through hole;
a driving member, rotatably disposed in the assembling hole of the first portion, the driving member including a first end and a second end, the first end including a driving portion, the second end including an abutting portion, the abutting portion being able to go into the through hole via the rotation of the driving member; and
an insert, detachably assembled with the second portion and in the through hole.

2. The dismantling device of claim 1, wherein the second portion including a lateral opening extending radially along the through hole, and the abutting portion goes through the lateral opening and into the through hole as the driving member rotates to drive the abutting portion.

3. The dismantling device of claim 1, wherein the abutting portion is disposed eccentrically on the driving member.

4. The dismantling device of claim 1, wherein the abutting portion is formed as a circular plate.

5. The dismantling device of claim 1, wherein a circumferential surface of the abutting portion is formed with a frictional structure.

6. The dismantling device of claim 1, wherein the insert is disposed on one side of the second portion remote from the first portion.

7. The dismantling device of claim 1, wherein the second portion is formed with an assembling portion, the assembling portion is formed as a generally arcuate recess, and the insert and the assembling portion are detachably assembled and positionally engaged with each other.

8. The dismantling device of claim 7, wherein the insert includes a connection portion and a head portion, the connection portion is assembled to the assembling portion, and the head portion extends into the through hole.

9. The dismantling device of claim 8, wherein the head portion includes corresponding first surface and second surface, the first surface is engaged with an inner surface in the through hole of the second portion, and the second surface faces the first portion.

10. The dismantling device of claim 9, wherein the second surface is formed with a concave surface.
